(19) United States
(12) Patent Application Publication
(10) Pub. No.: US 2012/0088097 A1
(43) Pub. Date: Apr. 12, 2012

(54) Nanometallic Transportable Graphic System

(76) Inventors: Ralph Giammarco, New Berlin, WI (US); Michael Kolman, West Allis, WI (US)

(21) Appl. No.: 13/326,080

(22) Filed: Dec. 14, 2011

Related U.S. Application Data
(60) Provisional application No. 61/528,502, filed on Aug. 29, 2011.

(51) Int. Cl. B32B 5/16; B32B 7/12; B32B 38/10; B05D 5/06; B32B 37/14

(52) U.S. Cl. 428/328; 427/401; 156/249; 428/343

(57) ABSTRACT

The present invention is a nanometallic transportable graphic system with a metallically infused target surface adhesion layer (TSAL) thermally bonded to a metallically infused protection layer. The metal nanoparticles create a nano-ionic bond force field which enables the transportable graphic apparatus to adhere to any substantially uniform surface capable of forming a uniform surface bond.

### CROSS-REFERENCE TO RELATED APPLICATIONS

This application claims priority to U.S. Provisional Application No. 61/528,502, entitled “Transportable Graphic and System,” filed Aug. 29, 2011.

### FIELD OF INVENTION

The present invention relates to the field of printing materials and substrates and more specifically to a multi-layered metallically infused graphics film adapted to conform to multiple surface textures, almost all user-selected adhesion processes and to nearly all standard printer and ink types.

### TERMS OF ART

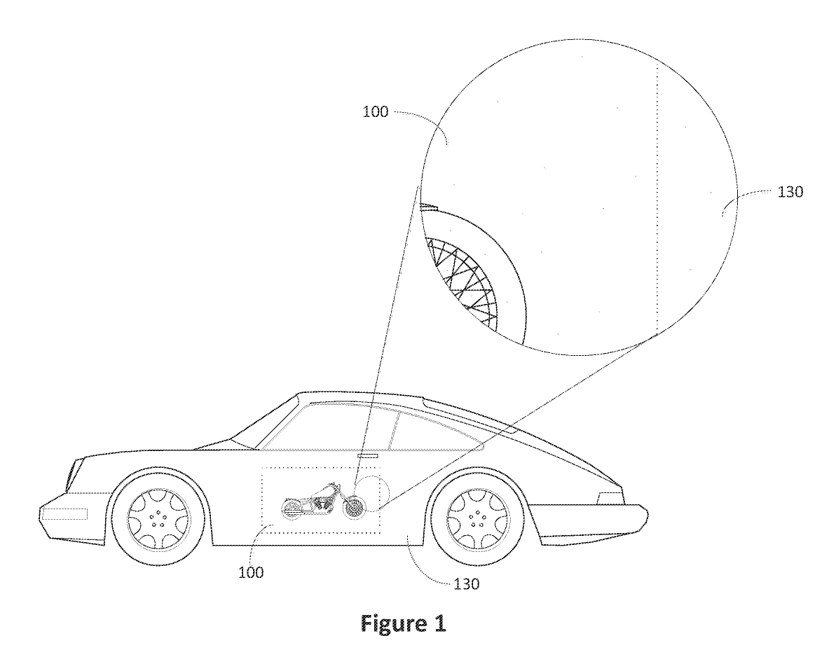

FIG. 1 illustrates an exemplary nanometallic graphic binding to a metallic surface.

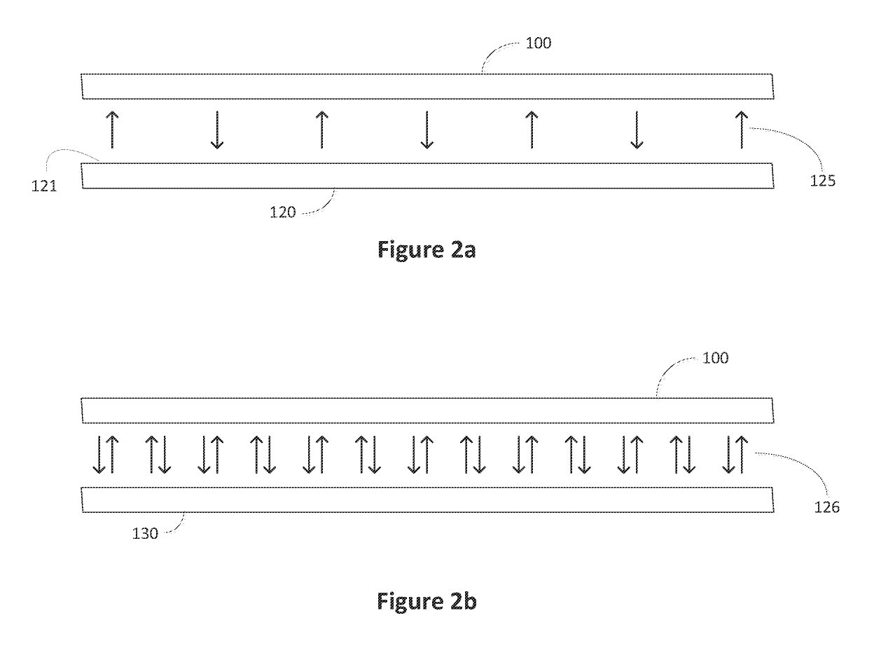

FIG. 2a illustrates an exemplary nanometallic graphic binding to its carrier component.

FIG. 2b illustrates an exemplary nanometallic graphic binding to a target surface.

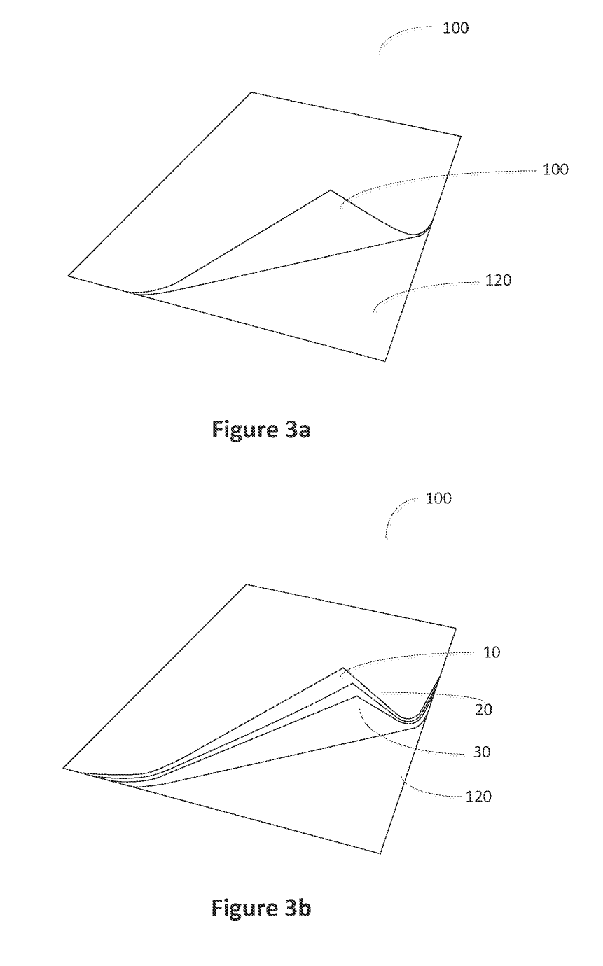

FIG. 3a shows an exemplary nanometallic graphic partially separated from its carrier.

FIG. 3b shows the individual layers of an exemplary nanometallic graphic.

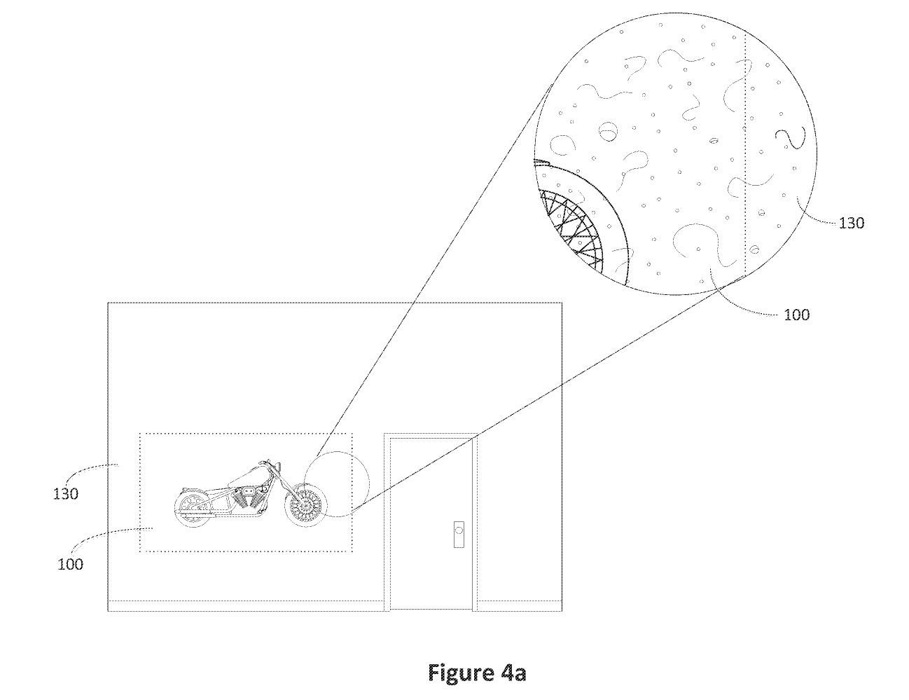

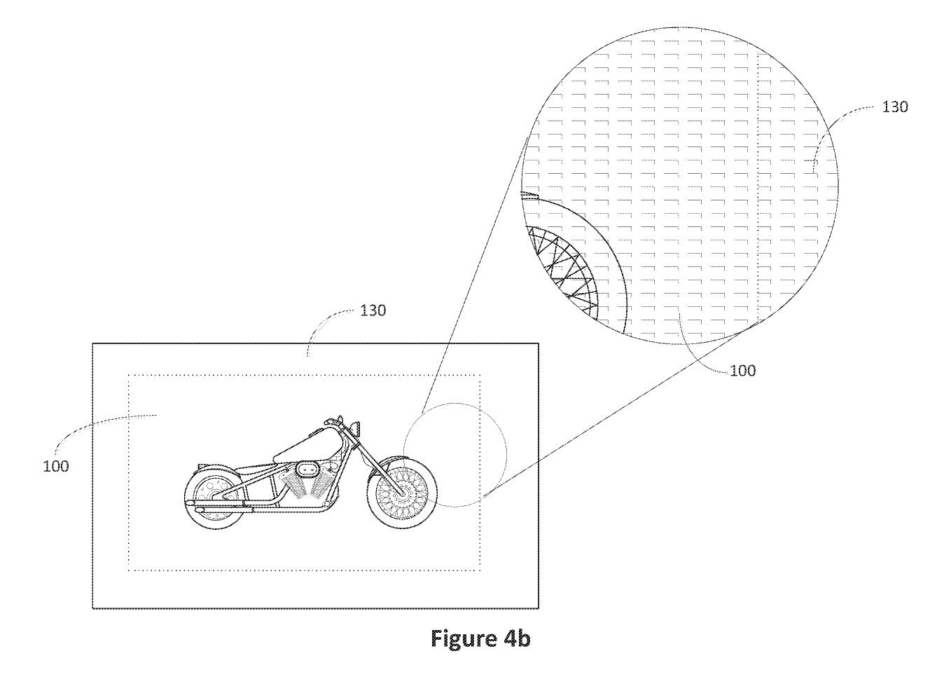

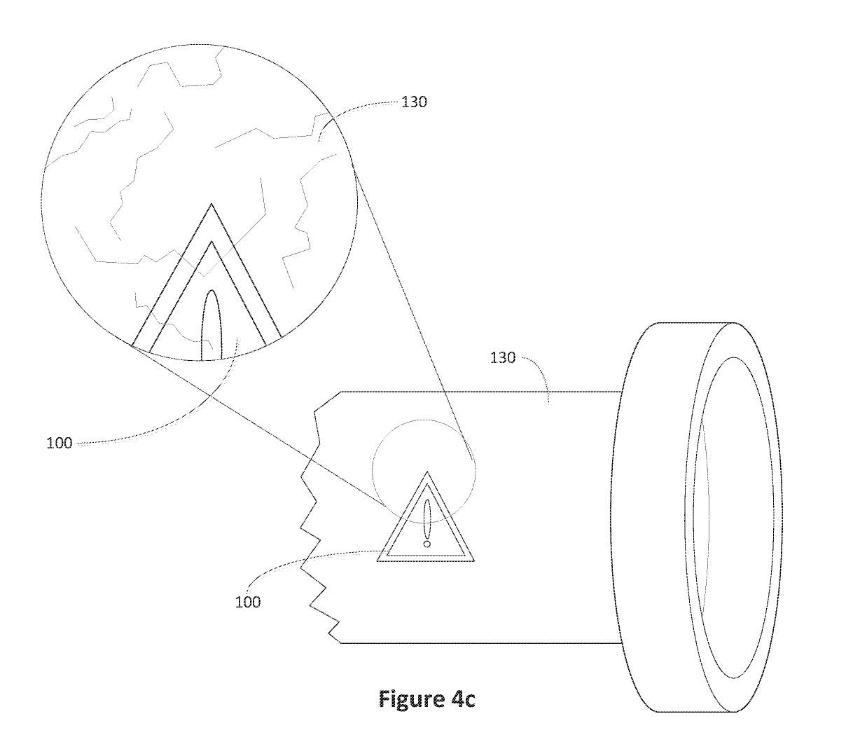

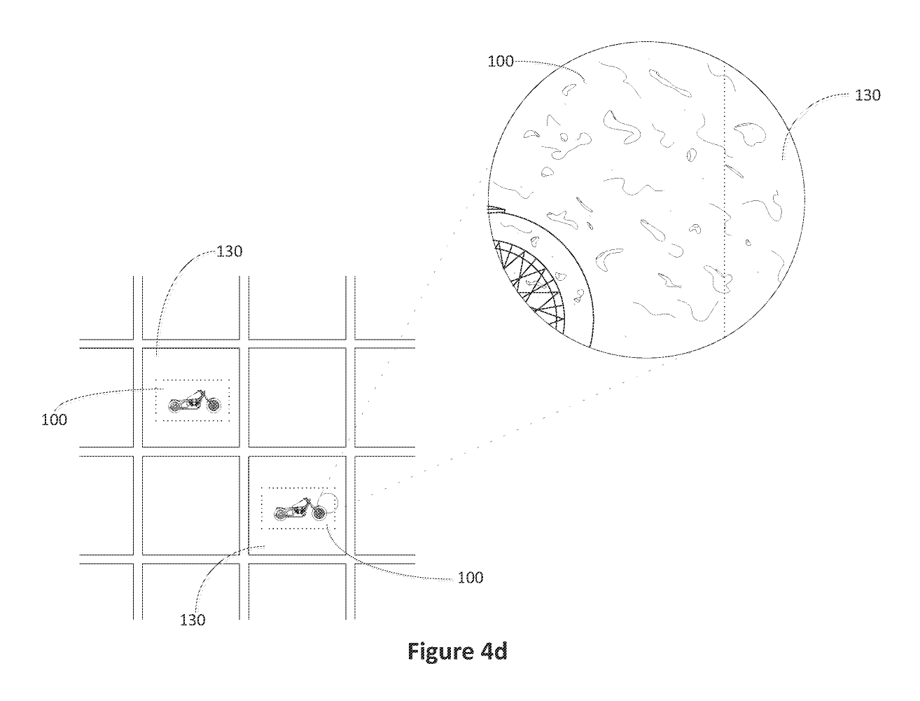

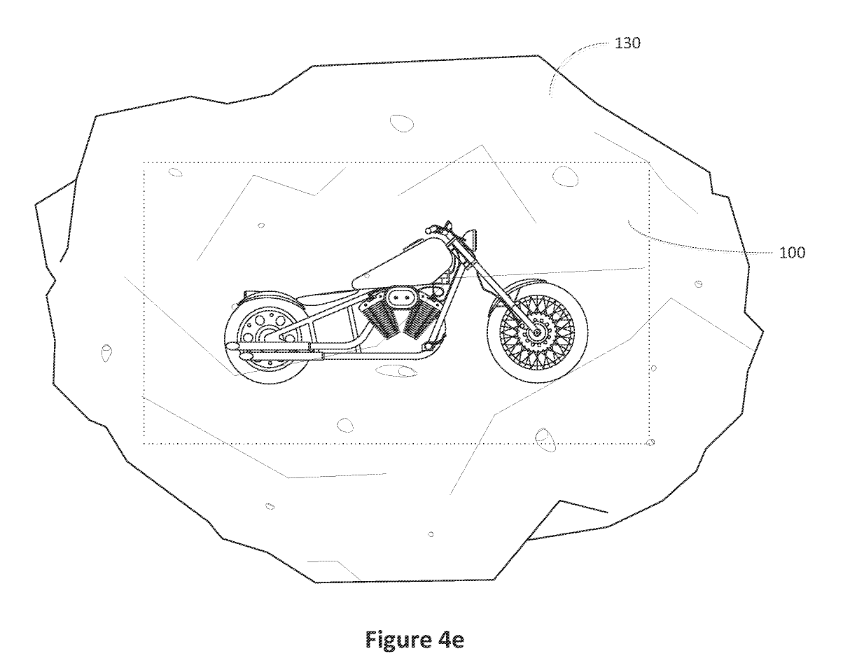

FIGS. 4a, 4b, 4c, 4d and 4e illustrate an exemplary nanometallic graphic binding and conforming to various textured surfaces, specifically the surfaces of a textured wall, canvas, tile, a pipe and a rock.

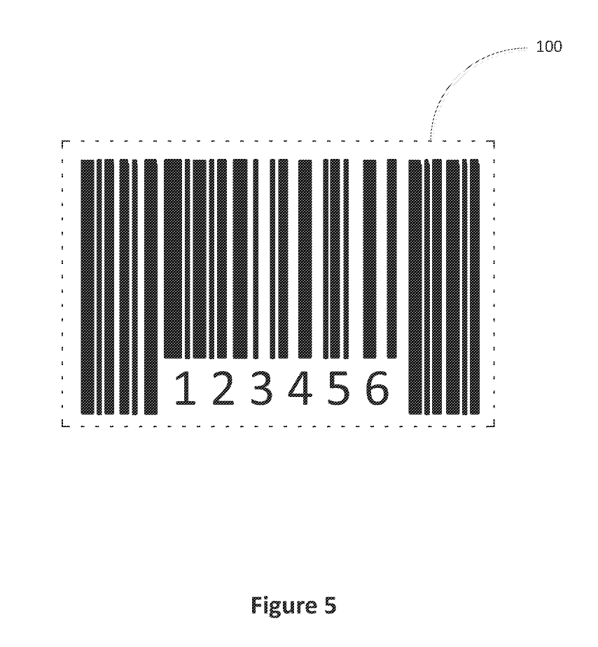

FIG. 5 illustrates an exemplary nanometallic graphic used as a barcode.

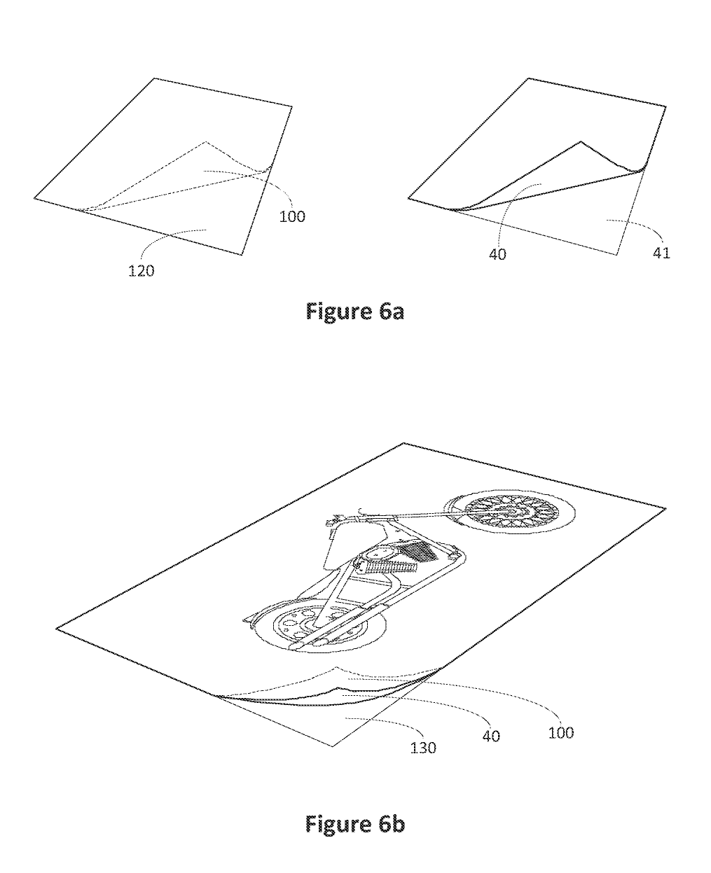

FIGS. 6a and 6b illustrate nanometallic transportable graphic in use with effects layer.

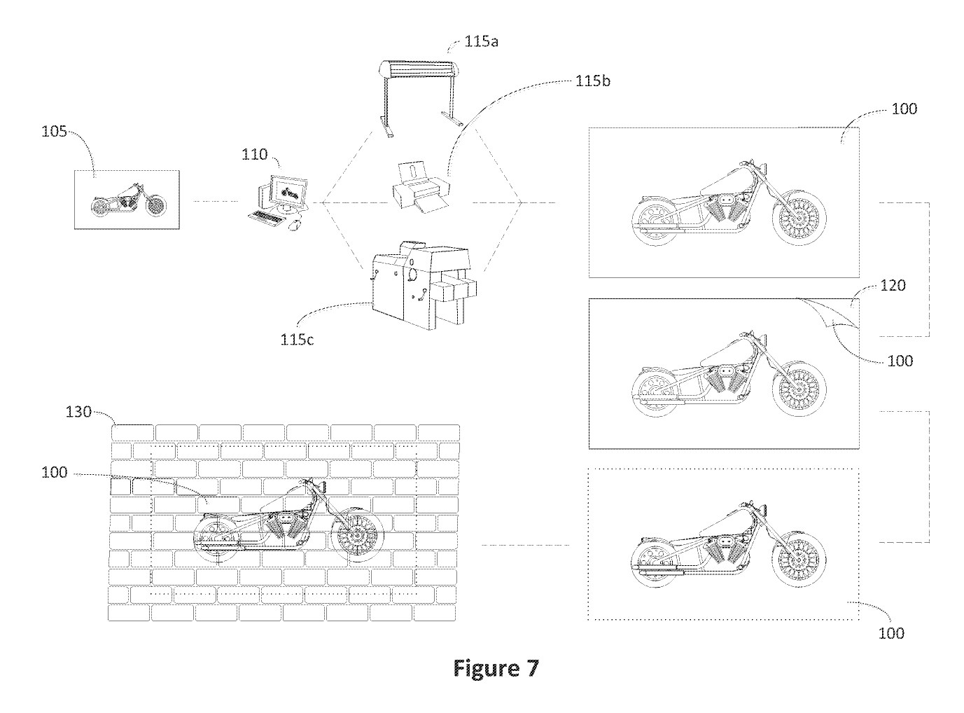

FIG. 7 illustrates an exemplary system for creating a nanometallic graphic.

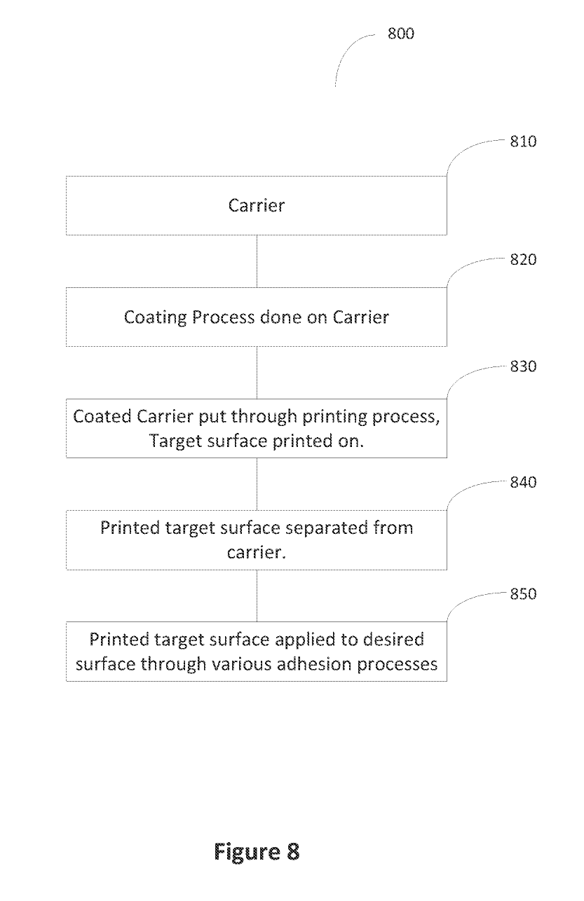

FIG. 8 is a flow chart illustrating an exemplary method for creating a nanometallic graphic.

### TERMS OF ART

As used herein, the term “electromagnetic binding surface” means any surface, regardless of materials, contours and porosity, which is sufficiently free from solid particulate matter (e.g., impurities and dust) and liquids so as to allow the formation of a nano-ionic bond.

As used herein, the term “ink absorption” refers to the ability of a material of one state, such as a solid, to incorporate ink in a second state, such as liquid.

As used herein, the term “ink retention” refers to the ability of a material to continually possess or hold ink. Ink retention is measured using any method known in the art, including the cross-hatch adhesion test.

As used herein, the term “metallically infused” means having a composition in which one or more metallic particles are dispersed or suspended.

As used herein, the term “metallically infused target surface adhesion layer (TSAL)” means a layer constructed from liquid polymer or polyurethane and known in the art infused with metallic particles including, but not limited to, copper, saver, platinum, zinc, zirconium, gold, iridium, metal alloys and combinations of these metallic particles and other alloys. A metallically infused TSAL bonds inks or toners and a target surface.

As used herein, the term “metallically infused effects layer” means a layer containing an aesthetic effect, such as a background color(s), glitter, metallic finish, pearlization, or other effect, infused with metallic particles including, but not limited to, copper, silver, platinum, zinc, zirconium, gold, iridium, metal alloys and combinations of these metallic particles and various other alloys. A metallically infused effects layer provides a background layer to a completed nanometallic transportable graphic.

As used herein, the term “metallically infused protection layer” means a layer constructed from acrylic and known in the art infused with metallic particles including, but not limited to, copper, silver, platinum, zinc, zirconium,gold, iridium, metal alloys and combinations of these metallic particles and various other alloys. A metallically infused protection layer protects a metallically infused target surface adhesion layer and any bound inks from mechanical, chemical and environmental degradation.

As used herein, the term “nano-ionic bond force field” means an ionic bond which is created by the presence of nanometallic particles in one surface that bond to the nanometallic particles in another surface without the use of adhesive. A nano-ionic bond force field creates a physical bond between the surfaces.

As used herein, the term “polyacrylate” means a material created of acrylate polymers. Polyacrylate is usually transparent and has sore elasticity.

As used herein, the term “polyolefin” means a polymer created from an olefin, or alkene, as a monomer.

As used herein, the term “polyurethane means a material created by a polymer chains containing a plurality of organic units joined by carbonate (urethane) links. Polyurethane is usually elastic and durable and experiences less wear than other similar materials.

As use herein, the term “target surface” means a surface on which ink is deposited.

### BACKGROUND

The market for color digital printing systems currently exceeds $109 billion a year.

Advancements in printing technologies have typically involved improvement of the efficiency of processes in existing markets for existing uses. Far less innovation has been focused on expanding into non-traditional printing markets by overcoming limitations in the printing process itself. In particular, improvements to graphic media and interaction of the media with a printer have been relatively limited.

Presently, the most significant limitation of the printing process is the printer itself. Printers are costly and only able to receive and process limited types of media. In order to embellish a surface with a printed image, the image must be produced on a media which can fit within the printer and which is specifically adapted to receive the inks that a particular printer is adapted to process.

A surprisingly narrow range of materials can be processed by printers. A user may, potentially, want to embellish walls, vehicles, machinery, appliances, windows, furnishing, plumbing and electrical components, flooring and even surfaces underwater. Currently, this is not possible because of the limitations of print media.

Every potential surface to which a printed image could conceivably be adhered has a unique surface texture. For example, a brick wall has a texture and porosity distinctively different than drywall. A wall to which paint having sand particles in it has been applied will have noticeably different surface characteristics than a glossy, the wall.

While inks have evolved to adapt to meet the needs of a range of surface materials needs, the materials on which images, or “print media,” can printed are far less adaptable.

Even the most advanced color graphic printing technology known in the art provides a graphic image that can only be used on a limited number of surfaces, with a disappointing effect.

Although there are a limited number of available graphic materials known in the art, there are infinite types of surfaces a user may want to embellish. Each surface has its own quasi-unique texture and surface characteristics.

Invariably, the texture of the surface which is to be embellished by printed material is dramatically different than the surface and texture of the graphic. Thus, the appearance of even the highest resolution graphic may have the “slapped on” effect of a bumper sticker due to the mismatched textures of the graphic media and the underlying surface.

After printing, the graphic material must be adhered to a surface, such as a wall, fixture or vehicle. The adhesion method varies with the weight and type graphic media, and can be a hit-or-miss proposition for a user. Adhesives add bulk, are difficult to apply and permanently damage underlying surfaces. With adhesives, a user generally does not have the option of temporarily affixing an image to a surface.

Because print media are limited by the cost of the equipment and adhesion methods are complex, it is difficult to develop printed products that span more than limited market segments. However, a print product that can be cross-marketed to more than one segment will be lucrative.

For example, digital printing is used in multiple industries, from the $12 billion sign industry to the $1.32 billion photography publishing industry. Other industries, including, but not limited to, the display industry (e.g., banners, signs, posters, point-of-purchase displays), graphics industry, industrial identification industry, textile industry, auto industry, packaging industry and advertising industry also use digital printing technologies. Currently, different methods and products are required for printing the graphics for each of these industries.

There is an unmet need for a graphic media and carrier system that can be universally used with all or most printers known in the art.

There is an unmet need for a graphic media that can be universally adapted for any adhesion method.

There is an unmet need for a graphic media that can conform to an infinite range of surface textures to create a seamless aesthetic appearance.

There is an unmet need for a graphic material which reduces the number of layers and the weight of substrate materials.

There is an unmet need for a graphic material and carrier system which can be adapted for specific printing processes and span multiple lucrative market segments with minimal adaptation of the underlying technology.

There is an unmet need for a graphic media and carrier system that can create entirely new markets for printed products by enabling the embellishment of surfaces which have been assumed to not be amenable to printing processes.

### SUMMARY OF THE INVENTION

The present invention is a nanometallic transportable graphic system with a metallically infused target surface adhesion layer (TSAL) thermally bonded to a metallically infused protection layer. The metal nanoparticles create an nano-ionic bond force field which enables the nanometallic graphic apparatus to adhere to any substantially uniform surface capable of forming a uniform surface bond.

### DETAILED DESCRIPTION OF INVENTION

For the purpose of promoting an understanding of the present invention, references are made in the text to exemplary embodiments of a nanometallic graphic apparatus and system, only some of which are described herein. It should be understood that no limitations on the scope of the invention are intended by describing these exemplary embodiments. One of ordinary skill in the art will readily appreciate that alternate but functionally equivalent materials and structures may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

FIG. 1 illustrates an exemplary nanometallic transportable graphic 100.

Nanometallic transportable graphic 100 is shown bound to target surface 130, in the exemplary embodiment shown is a car. Target surface 130 is smooth, and nanometallic transportable graphic 100 conforms to the smooth surface of target surface 130 to create a seamless look along the car, even in areas where nanometallic transportable graphic 100 is bound.

In the exemplary embodiment shown in FIG. 1, nanometallic transportable graphic 100 is an image of a motor cycle on a clear background. The entirety of nanometallic transportable graphic 100 mimics the surface texture of target surface 130, creating the effect that the motorcycle image on nanometallic transportable graphic 100 is one continual surface with target surface 130.

In the exemplary embodiment shown in FIG. 1, no adhesive or other treatment is necessary to apply nanometallic transportable graphic 100 to target surface 130. Target surface 130, which in the exemplary embodiment shown is a car, contains metallic particles, which creates a strong non-chemical bond between target surface 130 and nanometallic transportable graphic 100, which is infused with nanometallic particles. No adhesive or other treatment is necessary for other surfaces containing metallic coatings or metal particles.

The non-chemical bond created between nanometallic transportable graphic 100 and target surface 130 with metallic particles also reinforces the strength and structure of nanometallic transportable graphic 100 while allowing nanometallic transportable graphic 100 to maintain its flexibility and elastic qualities. For example, exemplary nanometallic transportable graphic 100 shown in FIG. 1 has dual orientation, meaning nanometallic transportable graphic 100 stretches equally in all directions. Nanometallic transportable graphic 100 can therefore cover irregular surfaces without tearing or interfering with the overall shape of the image. Nanometallic transportable graphic 100 may also be applied using physical pressure.

While adhesives and other binding treatments are not necessary, in some exemplary embodiments, adhesives or treatments may be desired to more securely apply nanometallic transportable graphic 100 to certain surfaces. For example, in some exemplary embodiments, adhesives, such as tape, glues, or epoxies, may be beneficial in securing nanometallic transportable graphic 100. In still further exemplary embodiments, treatments, such as the application of heat, may be beneficial in securing nanometallic transportable graphic 100. However, nanometallic transportable graphic 100 is capable of forming a nano-ionic bond force field with target surface 130 to allow nanometallic transportable graphic 100 to stick to target surface 130 without adhesives or other treatments.

FIGS. 2a and 2b illustrate the nano-ionic bond force field formed between nanometallic transportable graphic 100, infused with nanometallic particles, and its carrier component 120 and a target surface 130.

As illustrated in FIG. 2a, nanometallic transportable graphic 100 binds to carrier component 120, with release surface 121. Nanometallic transportable graphic 100, and in some exemplary embodiments carrier component 120, is infused with nanometallic particles including, but not limited to, copper, silver, platinum, zinc, zirconium, gold, iridium, metal alloys and combinations of these metallic particles and various other alloys, creating nano-ionic bond force field 125 between nanometallic transportable graphic 100 and carrier component 120.

Carrier component 120 functions as a base layer which stabilizes nanometallic transportable graphic 100 during the printing process. Release surface 121 is specifically designed to be easily disengaged from nanometallic transportable graphic 100, and specifically the protection layer 20 (illustrated in FIG. 3b), or finishing layer 30 (illustrated in FIG. 3b) if a finishing layer is used, while still providing a stable and uniform surface adhesion. In some embodiments, release surface 121 may be designed with a low concentration of nanometallic particles in order to easily disengage nanometallic transportable graphic 100.

In some exemplary embodiments, release layer 121 may be specifically designed for use with smooth or embossed finishing layers 30 (not shown) to create a gloss or matte finished product.

FIG. 2b illustrates an exemplary nanometallic transportable graphic 100 binding to target surface 130. Nanometallic transportable graphic 100, and in some exemplary embodiments target surface 130, are infused with nanometallic particles including, but not limited to, copper, silver, platinum, zinc, zirconium, gold, iridium, metal alloys and combinations of these metallic particles and various other alloys, creating nano-ionic bond force field 126.

As illustrated in FIGS. 2a and 2b, nano-ionic bond force field 126 is stronger than nano-ionic bond force field 125, which means nanometallic transportable graphic 100 binds more tightly to target surface 130 than carrier component 120.

In some exemplary embodiments, nano-ionic bond force fields 125 and 126 are resilient to temperature, moisture, acid, pressure and solvents, allowing nanometallic transportable graphic 100 to securely bind to carrier component 120 or target surface 130. However, nano-ionic bond force fields 125 and 126 may be interrupted by certain forces or substances in order to remove nanometallic transportable graphic 100 from carrier component 120 and target surface 130. For example, in some exemplary embodiments, nano-ionic bond force fields 125 and 126 may be interrupted by certain physical means, including, but not limited to, certain fluids or forces stronger than the attractive force which is creating nano-ionic bond force fields 125 and 126.

In the exemplary embodiments shown in FIGS. 2a and 2b, nanometallic transportable graphic 100 and carrier component 120 may contain a plurality of nanometallic or metallic particles distributed throughout their volumes. In some exemplary embodiments, metallic particles may be evenly or unevenly distributed. In further exemplary embodiments, metallic particles may be contained within individual layers of nanometallic transportable graphic 100.

In the exemplary embodiments described, metallic particles are of the same substance and oriented in the same direction. In further exemplary embodiments, metallic particles may be oriented in different directions. In still further exemplary embodiments, nanometallic transportable graphic 100 may contain nanometallic particles of different substances. For example, nanometallic particles may be copper, silver, platinum, zinc, zirconium, gold, iridium, metal alloys and combinations of these metallic particles and various other alloys.

In exemplary embodiments where metallic particles are contained within layers of nanometallic transportable graphic 100, each layer may contain a different type of metallic particle,different concentration of metallic particles and/or different orientation or distribution of metallic particles. In some exemplary embodiments, metallic particles may be specifically chosen to help bind nanometallic transportable graphic 100 to a specific target surface.

In the exemplary embodiments described, the concentration of nanometallic particles in the layers of a nanometallic transportable graphic 100 range between 10 parts-per-million (ppm) to 100 ppm. In some embodiments, the concentration of nanometallic particles may be varied depending on the bonding strength, or peel force (measured in grams per inch), desired and the bonding surface. For example, as the concentration of nanometallic particles increases, the strength of the nano-ionic bond force field increases for a given surface. However, the strength ceases to increase once a maximum concentration is reached. The resulting values create an adhesion curve. The specific concentration of nanometallic particles for a transportable graphic 100 may be selected based on the adhesion curve for a desired target surface.

Depending on the nanometallic particles present in nanometallic transportable graphic 100 and/or a target surface, nano-ionic bond force fields 125 and 126 may form more readily at certain temperatures. In the exemplary embodiments described, nano-ionic bond force fields 125 and 126 are readily formed and maintained at temperatures between −40 and 400 degrees Fahrenheit without the use of additional adhesives or other treatments. In some exemplary embodiments, nano-ionic bond force fields 125 and 126 may form outside of that temperature range if adhesives or treatments are used.

In addition to creating nano-ionic bond force fields, nanometallic particles distributed throughout nanometallic transportable graphic 100 enhance the durability of inks. The specific polymer or polymers used to create nanometallic transportable graphic 100 may also be selected for its ability to absorb and retain ink. For example, polyacrylate and polyurethane are two polymers known in the art which may be used for nanometallic transportable graphic 100.

In some exemplary embodiments, the specific polymer or polymers used may also be selected for their ability to manifest high heat, which is important for bonding and conforming to target surfaces.

In various embodiments, nanometallic transportable graphic 100 may be used to adhere any image to any surface using any printer known in the art, including but not limited to digital and traditional presses, laser printers and aqueous, solvent, low-solvent, latex and UV-curable inkjet printers.

In the embodiment shown, nanometallic transportable graphic 100 conforms to the texture of any surface to which it is applied. While no additional treatment is necessary, depending on the method used to apply it, such as heat, liquid, primer or adhesive, adhesion may be permanent or temporary.

By creating a non-chemical bond using nanometallic particles, it is possible to rotate, flex and reposition nanometallic transportable graphic 100. The nanometallic particles allow nanometallic transportable graphic 100 to be rotated. This non-chemical bond is temporary and may be subsequently be broken and reestablished. The bond may be broken solely by physical or mechanical means, such as physically pulling or separating, as distinguished from chemical means (other than water or physical dilution) known in the art.

Infusion of the nanometallic particles causes nanometallic transportable graphic 100 to remain pliable during the curing process, allowing nanometallic transportable graphic 100 to conform to the substrate's texture and contours. It is critical to use a nanometallically-infused graphic material which as the durability of cured film, but retains the flexibility of uncured film. In the exemplary embodiment described, nanometallic transportable graphic 100 is printed on a thin, nanometallic particle infused film, which remains pliable during curing. The nanometallically-infused graphic medium creates a non-chemical bond with substrates.

In the embodiment shown, the use of nanometallic particles smaller than 0.75 nm is, allowing for greater light transmission and less light absorption, is critical. Metallic particles of a larger proportional size would cause the graphics material to darken. Preferably, nanometallic particles will have a size in the critical range of 0.25 nm to 0.65 nm.

FIG. 3a shows an exemplary nanometallic transportable graphic 100 partially separated from its carrier component 120. As illustrated, nanometallic transportable graphic 100 separates from carrier component 120 as a single, thin sheet. However, in some embodiments, nanometallic transportable graphic 100 may contain multiple layers or coatings, although still retaining the thinness, flexibility and appearance of a single, thin sheet.

In the exemplary embodiments described, carrier component 120 is a single-use, disposable carrier. However, in further exemplary embodiments, carrier component 120 may be double-sided or reusable. For example, carrier component 120 may contain layers for nanometallic transportable graphic 100 on both its upper and lower surface. In some embodiments, a double-sided carrier component 120 may contain one side configured to generate a nanometallic transportable graphic 100 with a matte finish, while the other side may be configured to generate a nanometallic transportable graphic 100 with a glossy finish. In further exemplary embodiments, both sides may be configured to provide identical finishes.

In still further exemplary embodiments, carrier component 120 may include a durable, reusable portion with a disposable liner or other surface or layer which is removable from both nanometallic transportable graphic 100 and carrier component 120.

As illustrated in FIG. 3a, carrier component 120 is a durable paper layer having a polyolefin, polyester or polyethylene substrate. The substrate diminishes the strength of the nano-ionic bond force field created between carrier component 120 and nanometallic transportable graphic 100. In further exemplary embodiments, other substrates or coatings may be used to diminish the strength of the nano-ionic bond force field formed between carrier component 120 and nanometallic transportable graphic 100. For example, polyethylene may be used in other exemplary embodiments, as a transportable graphic will not stick well to polyethylene.

By diminishing the strength of the nano-ionic bond force field created between carrier component 120 and nanometallic transportable graphic 100, nanometallic graphic 100 becomes selectively releasable from carrier component 120.

For example, FIG. 3b shows the individual layers which may make up nanometallic transportable graphic 100. As illustrated in FIG. 3b, nanometallic transportable graphic 100 contains printable target surface adhesion layer (TSAL) 10, protection layer 20 and finishing layer 30. While drawn in FIG. 3b as individual, peeled back layers, layers 10, 20 and 30 are sufficiently bound with one another to be one and part of the same sheet making up nanometallic transportable graphic 100. Some exemplary embodiments may omit finishing layer 30 or include additional protective or aesthetic layers.

In the exemplary embodiment shown, printable TSAL 10 and protection layer 20 are metallically infused. Printable TSAL 10 has a non-porous outer surface which receives ink. Because printable TSAL 10 is metallically infused, ink containing organometallic particles will create an ionic bond to printable TSAL 10.

In some exemplary embodiments, printable TSAL 10 may be patterned or colored. In still further exemplary embodiments, printable TSAL 10 may contain an ink substrate. Inks in an ink substrate may include, but are not limited to, solvents, UV inks, latex inks, flexo inks, offset inks, organometallic inks and combinations of inks. Inks may also be liquid inks or dry toner-style inks.

In other exemplary embodiments, TSAL 10 may have multiple sub-layers to create different color or aesthetic effects or provide additional thickness to nanometallic transportable graphic 100. For example, in some exemplary embodiments, TSAL 10 may contain sub-layers with different ink distributions to produce a color effect.

As illustrated in FIG. 3b, finishing layer 30 is a single layer which directly contacts carrier component 120. Finishing layer 30 helps keep nanometallic transportable graphic 100 loosely bound to and easily removed from carrier component 120. Finishing layer 30 may also provide an aesthetic quality to nanometallic transportable graphic 100, such as a gloss or matte finish. Finishing layer 30 may also aid in creating an ionic bond with a target surface.

In some exemplary embodiments, protection layer 20 may include finishing substances. For example, protection layer 20 may have a gloss finish with a light reflectivity index between 120 and 150 gloss units. In other exemplary embodiments, protection layer 20 may be considered a matte finish, with a light reflectivity index between 2 and 20 gloss units.

Protection layer 20 protects printable TSAL 10 from mechanical, chemical and environmental degradation. In the exemplary embodiment shown, protection layer 20 is structured to block ultraviolet light to prevent ink from fading. In further exemplary embodiments, protection layer 20 may contain additional light-blocking properties. In some exemplary embodiments, nanometallic particles imbedded in protection layer 20 or other layers of nanometallic transportable graphic 100 work to block ultraviolet light. In other exemplary embodiments, off-the-shelf ultraviolet-blocking materials or coatings may be used alone or in conjunction with nanometallic particles. By blocking ultraviolet light, the life of the ink used in nanometallic transportable graphic 100 is extended.

In the exemplary embodiment shown,layers 10, 20 and 30 of nanometallic transportable graphic 100 are thermally bound together to create a single component or sheet. In further exemplary embodiments, layers 10, 20 and 30 may be pressed or otherwise bound to create a single component or sheet.

While in the exemplary embodiment illustrated in FIG. 3b, nanometallic transportable graphic 100 is illustrated as having three layers 10, 20 and 30 which loosely adhere to carrier component 120, in further exemplary embodiments, nanometallic transportable graphic 100 may contain more or fewer layers. In still further exemplary embodiments, some layers may contain sub-layers or components. For example, protection layer 20 may contain a waterproofing component, UV protection component, and/or a museum-grade preservative, among others.

FIG. 1 illustrated an exemplary nanometallic transportable graphic 100 binding to a smooth target surface which also contained metallic particles. However, in further exemplary embodiments, nanometallic transportable graphic 100 may bind to any target surface 130, including porous and non-porous surfaces, smooth surfaces, rough surfaces, irregular surfaces, and surfaces with our without metallic particles. The exemplary embodiments described in FIGS. 4a-4e illustrate further examples of nanometallic transportable graphic 100 binding to different target surfaces 130.

FIG. 4a illustrates an exemplary nanometallic transportable graphic 100 binding to target surface 130, which in the exemplary embodiment shown is a textured wall. As illustrated in FIG. 4a, the texture of the wall is shown through nanometallic transportable graphic 100, even where the image of nanometallic transportable graphic 100 is visible. As a result, nanometallic transportable graphic 100 conforms to the texture of target surface 130.

As illustrated in FIG. 4a, target surface 130 has an uneven, inconsistent surface texture. The uneven, inconsistent surface texture is adopted by nanometallic transportable graphic 100 to give the appearance of a consistent texture throughout target surface 130, even where nanometallic transportable graphic 100 is positioned.

FIG. 4b illustrates an exemplary nanometallic transportable graphic 100 binding to target surface 130, which in the exemplary embodiment shown is a pre-stretched canvas. Target surface 130 of pre-stretched canvas has an even, consistent surface texture. The even, consistent surface texture of target surface 130 is adopted by nanometallic transportable graphic 100, resulting in a constant texture across the entire surface of target surface 130, even where nanometallic transportable graphic 100 is bound.

In the exemplary embodiments illustrated in FIGS. 4a and 4b, nanometallic transportable graphic 100 is an image of a motorcycle with a clear background. Nanometallic transportable graphic 100 is not cut to the shape or size of the motorcycle image. The entirety of nanometallic transportable graphic 100, including the clear background and motorcycle image, adopt the texture of target surfaces 130.

Neither target surface 130 illustrated in FIGS. 4a and 4b contains metallic particles. However, the nanometallic particles embedded in nanometallic transportable graphic 100 are capable of forming nano-ionic bond force fields with any particles in a target surface 130 which may support a nano-ionic bond force field.

In other exemplary embodiments, nanometallic transportable graphic 100 may only include a graphic image or be cut to the size and shape of a printed graphic. For example, FIG. 4c illustrates an exemplary nanometallic transportable graphic 100 binding to target surface 130. In the exemplary embodiment shown, nanometallic transportable graphic 100 is a warning sticker, and target surface 130 is a pipe with a chipped and cracked coating.

As illustrated in FIG. 4c, nanometallic transportable graphic 100 conforms to the chips and cracks on target surface 130 to create a consistent textured look across the surface of the pipe. By conforming to the surface texture of target surface 130, nanometallic transportable graphic 100 is more tightly bound to target surface 130 than another graphic which does not conform to the surface texture of a target surface. For example, a graphic with a rigid backing would not completely bind along its entirety to a target surface. Similarly, if an adhesive were necessary, the adhesive would be drawn away from the graphic by the chips and cracks in the pipe. Nanometallic transportable graphic 100, on the other hand, is capable of matching the surface texture of the pipe, and therefore contacts target surface 130 completely.

In the previous exemplary embodiments described in FIGS. 4a-4c, nanometallic transportable graphic 100 is binding to a porous textured target surface 130. As a nano-ionic bond force field forms between nanometallic transportable graphic 100 and a porous target surface 130, nanometallic transportable graphic 100 conforms to all the contours and surface textures of target surface 130.

FIG. 4d illustrates an exemplary nanometallic transportable graphic 100 binding to target surface 130, which in the exemplary embodiment shown is a bathroom wall tile. Because nanometallic transportable graphic 100 does not require adhesives or treatments, nanometallic transportable graphic 100 is able to remain bound to surfaces which experience a wide range of environmental conditions, including the humidity and heat experienced in a bathroom. Nanometallic transportable graphic 100 is even able to withstand cleaning. In some exemplary embodiments, nanometallic transportable graphic 100 may include a museum-grade preservative which increases the durability of nanometallic transportable graphic 100.

As illustrated in FIG. 4d, nanometallic transportable graphic 100 takes on the texture of target surface 130, giving the appearance that the image on nanometallic transportable graphic 100 has been printed directly onto target surface 130.

While nanometallic graphic 100 may be used without adhesives or other treatments, it may be beneficial to use adhesives or treatments when binding nanometallic transportable graphic 100 to certain surfaces, such as bathroom tiles, which may experience harsher environments or excessive wear.

FIG. 4e illustrates an exemplary nanometallic transportable graphic 100 binding to target surface 130, which in the exemplary embodiment shown is a rock. As illustrated in FIG. 4e, target surface 130 has an inconsistent, rough surface texture. Nanometallic transportable graphic 100 takes on the surface texture of target surface 130 so target surface 130 does not lose its inconsistent, rough surface texture.

As illustrated in FIG. 4e, nanometallic transportable graphic 100 is able to conform to the ridges, contours and other textural characteristics of target surface 130. In order to conform to larger ridges, contours and textural characteristics, nanometallic transportable graphic 100 is able to stretch and deform. The image on nanometallic transportable graphic 100, therefore, retains its proportions, despite the texture of target surface 130.

While nanometallic transportable graphic 100 does not require adhesives or other treatments to stick to target surfaces 130, including a rock, it may be desirable to use adhesives or treatments, such as the application of heat, to help nanometallic transportable graphic 100 tightly conform to the surface texture of a target surface. In further exemplary embodiments, target surface 130 may be cleaned of any particulate matter or liquids in order to allow a nano-ionic bond force field to form between nanometallic transportable graphic 100 and target surface 130.

FIG. 5 illustrates an exemplary nanometallic transportable graphic 100 used as a barcode. Because nanometallic transportable graphic 100 is able to conform to the surface texture of a target surface and withstand varying environmental conditions, nanometallic transportable graphic 100 is ideal for use as a barcode or other indicia of parts or products. For example, as products or parts are sent through ovens and washers, traditional stickers or removable indicia are inadvertently removed by the heat or water. In many instances, it is undesirable to permanently mark a part or product. Nanometallic transportable graphic 100, however, securely binds to a target surface and is durable enough to withstand the adverse conditions inflicted upon it.

In some exemplary embodiments, nanometallic transportable graphic 100 may be used only for internal identification. In other exemplary embodiments, nanometallic transportable graphic 100 may be used for permanent identification. Because nanometallic transportable graphic 100 may be safely removed without damaging a target surface, it is an ideal medium for this purpose.

While in the exemplary embodiment shown in FIG. 5, nanometallic transportable graphic 100 is a barcode, in other exemplary embodiments, nanometallic transportable graphic 100 may be another identifier or indicator. Nanometallic transportable graphic 100 may also be used to mark target surfaces with a logo, trademark or other identifying graphic or text.

FIGS. 6a and 6b illustrate nanometallic transportable graphic 100 in use with effects layer 40. As illustrated in FIG. 6a, effects layer 40 is a physically separately layer to nanometallic transportable graphic 100 to which nanometallic transportable graphic 100 may be bonded to provide a variety of visual effects.

In the exemplary embodiment shown, effects layer 40 is a metallically infused substrate bound to its carrier component 42 through a nano-ionic bond force field, similar to the manner in which nanometallic transportable graphic 100 is stably bound to its carrier 120. Once a graphic image is printed on TSAL 10, nanometallic transportable graphic 100 is removed from its carrier component 120 and placed on effects layer 40. As illustrated in FIG. 6b, effects layer 40 is therefore visible through any portion of nanometallic transportable graphic 100 not containing ink.

In the exemplary embodiment shown, nanometallic transportable graphic 100 creates a strong nano-ionic bond force field with effects layer 40. In other exemplary embodiments, an adhesive or adhering process may be used to bind nanometallic transportable graphic 100 and effects layer 40.

Because nanometallic transportable graphic 100 is bound to effects layer 40, effects layer 40 becomes the layer which binds to a target surface. Effects layer 40 and the target surface create a nano-ionic bond force field, which releasably joins the two surfaces.

In some exemplary embodiments, effects layer 40 creates a colored background or other visual effect (e.g., glitter, metallic finishing, pearlized finishing). In other exemplary embodiments, an effects layer may be provided for thickness and additional stability.

FIG. 7 illustrates an exemplary system for creating and using nanometallic transportable graphic 100. Image 105 is first entered into computer 110. Images may be scanned to a computer, digitally designed or transferred to a computer as a file. Image 105 is then printed. Any style of printer may be used, including, but not limited to, plotter 115a, desktop printer 115b and offset press 115c. In further exemplary embodiments, image 105 may be printed with offset press 115c without using computer 110.

Image 105 is printed as nanometallic transportable graphic 100 on carrier 120. Once removed from carrier 120, nanometallic transportable graphic 100 may be placed on any target surface 130, such as a brick wall as illustrated in FIG. 7. In further exemplary embodiments, nanometallic transportable graphic 100 may be of any size or shape and placed on any surface. The size, shape, clarity and resolution of nanometallic transportable graphic 100 are limited only by the properties of the printer used to print nanometallic transportable graphic 100.

In some exemplary embodiments, nanometallic transportable graphic 100 on carrier 120 may be run through a printer multiple times and receive multiple layers of ink. In some exemplary embodiments, nanometallic transportable graphic 100 may receive as many layers of ink through as many passes through a printer as the printer is capable of. In other exemplary embodiments, it y be desirable to limit the number of layers of ink and passes through a printer to achieve or retain an aesthetic quality.

As illustrated in FIG. 7, nanometallic transportable graphic 100 is removable from target surface 130, but not reusable. Once nanometallic transportable graphic 100 has been placed on a target surface 130, it cannot be removed without damaging nanometallic transportable graphic 100. Target surface 130, however, is not damaged by nanometallic transportable graphic 100.

In the exemplary embodiments illustrated, the force required to remove nanometallic transportable graphic 100 from a target surface 130 is 1 gram per linear inch width to 200 grams for liner inch width when pulled at 90 degrees.

FIG. 8 is a flow chart illustrating an exemplary method 800 for creating and using a nanometallic transportable graphic.

Step 810 is the step of developing a carrier. The carrier must loosely bind to the transportable graphic, but still bind the transportable graphic with sufficient strength to carry it through the printing process. The carrier may also be selected based on the type of printer being used.

The carrier must then be coated (Step 820) with the material which will become the transportable graphic. Different finishes, glosses and protective components may be considered when choosing the material which will become the transportable graphic.

Step 830 is printing an image to the transportable graphic material. Any printing process known in the art may be used to print to the transportable graphic.

Once an image has been printed, the transportable graphic is separated from the carrier (Step 840) and applied to the desired surface (Step 850). The transportable graphic may be applied to any surface and, while adhesives or other treatments are not necessary to apply the transportable graphic, an adhesive or other treatment may be desired to help the transportable graphic neatly and strongly adhere to a surface. Adhesives or other treatments may also help the transportable graphic more closely conform to any contours or textures of the surface to which it is being applied.

What is claimed is:

1. A nanometallic transportable graphic apparatus comprised of:
at least one printable, metallically infused target surface adhesion layer (TSAL) having a non-porous outer surface to which ink may be applied;
wherein said TSAL is integrally bound to at least one metallically infused protection layer; and
at least one variable, user-selected electromagnetic target surface;
wherein said metallically infused TSAL and said target surface create a first nano-ionic bonding force field between said metallically infused TSAL and said target surface.

2. The apparatus of claim 1 wherein said metallically infused TSAL and said metallically infused protection layer are infused with nanometallic particles.

3. The apparatus of claim 2 wherein said nanometallic particles are selected from the group consisting of copper, silver, platinum, zinc, zirconium, gold, iridium, metal alloys and combinations thereof.

4. The apparatus of claim 2 wherein said nanometallic particles are smaller than 0.75 nm.

5. The apparatus of claim 2 wherein said nanometallic particles have a size in the range of 0.25 nm to 0.65 nm.

6. The apparatus of claim 2 wherein the concentration of said nanometallic particles in each of said metallically infused TSAL and said metallically infused protection layer is between 1 ppm and 100 ppm.

7. The apparatus of claim 1 wherein said protection layer has a light reflectivity index between 120 and 150 gloss units and is characterized as a gloss finish.

8. The apparatus of claim 1 wherein said protection layer has a light reflectivity index between 4 and 20 gloss units and is characterized as a matte finish.

9. The apparatus of claim 1 which further includes a disposable carrier component which adheres to said protective layer by creating a second nano-ionic bond force field.

10. The apparatus of claim 9 wherein said first nano-ionic bond force field is stronger than said second nano-ionic bond force field.

11. The apparatus of claim 9 wherein said disposable carrier component is comprised of a paper layer with a polyolefin substrate, said polyolefin substrate causing a diminished second nano-ionic bond force field to be selectively releasable.

12. The apparatus of claim 9 wherein said disposable carrier component is comprised of a paper layer with a polyester substrate, said polyester substrate causing a diminished second nano-ionic bond force field to be selectively releasable.

13. The apparatus of claim 9 wherein said disposable carrier component is comprised of a paper layer with a polyethylene substrate, said polyethylene substrate causing a diminished second nano-ionic bond force field to be selectively releasable.

14. The apparatus of claim 1 wherein said TSAL further includes at least one ink substrate comprised of an ink selected from the group consisting of a solvent, UV ink, a latex ink, a flexo ink, an offset ink, organometallic ink and combinations thereof.

15. The apparatus of claim 1 wherein said TSAL further includes an ink substrate comprised of an ink selected from the group consisting of a liquid ink and a dry toner ink.

16. The apparatus of claim 1 wherein said TSAL further includes an ink substrate comprised of at least one aqueous ink jet ink.

17. The apparatus of claim 1 which further includes an optional adhesive layer which is a pressure sensitive layer.

18. The apparatus of claim 1 wherein said TSAL can be bonded to said target surface by applying heat though said protective layer or a binding layer.

19. A method of creating a nanometallic transportable graphic comprising the steps of:
developing a carrier infused with nanometallic particles capable of forming a nano-ionic bond force field;
coating said carrier with a coating infused with nanometallic particles capable of forming a first nano-ionic bond force field having a first strength with said carrier and a second nano-ionic bond force field having a second strength with a target surface, wherein said first strength is less than said second strength; and
printing an image on said coating on said carrier.

20. The method of claim 19 which further includes the steps of
removing said coating from said carrier; and
applying said coating to a target surface.

21. The method of claim 19 wherein said second nano-ionic bond force field is formed at temperatures between 40 and 400 degrees Fahrenheit without adhesive.
